(19) United States
(12) Patent Application Publication
(10) Pub. No.: US 2024/0412167 A1
(43) Pub. Date: Dec. 12, 2024

(54) AI-ASSISTED PRODUCT INNOVATION AND DEVELOPMENT PLATFORM AND METHOD WITH RISK DETECTION AND PREEMPTION

(71) Applicant: Stitch Technology Exploration Corporation, Basking Ridge, NJ (US)

(72) Inventors: Raghuram Kaushik Pillalamarri, Basking Ridge, NJ (US); Jan-Anders Mansson, West Lafayette, IN (US)

(21) Appl. No.: 18/736,348

(22) Filed: Jun. 6, 2024

Related U.S. Application Data
(60) Provisional application No. 63/471,637, filed on Jun. 7, 2023.
(60) Provisional application No. 63/471,678, filed on Jun. 7, 2023.

(51) Int. Cl. G06Q 10/10; G06Q 10/0637

(52) U.S. Cl. CPC G06Q 10/103; G06Q 10/0637

(57) ABSTRACT

An AI-assisted project risk detection platform include a plurality of data trackers configured to automatically collect relevant data associated with a project, the relevant data being selected from the group consisting of project scope, tasks, project management, budget, resources, project team members, project milestones, project timeline, project status, product launch plan, market trends, economic trends, competitive landscape, legal and regulatory environment, consumer behavior, consumer preferences, customer feedback, and social media. These data trackers are installed at critical points along project execution path or product launch plan. The platform further includes an AI-assisted data analysis module configured to receive the relevant data collected by the data trackers, analyze the relevant data, identify emerging vulnerabilities and issues associated with the project, and determine corrective recommendations. The platform generates and transmits notification messages to project team members and stakeholders to notify them about the identified vulnerabilities, issues, and the corrective recommendations.

### RELATED APPLICATION

This patent application claims the benefit of U.S. Provisional Patent Application Nos. 63/471,637 and 63/471,678, both filed on Jun. 7, 2023, both applications being incorporated herein by reference.

### FIELD

The present disclosure relates generally to a platform and a method for applying artificial intelligence (AI) to preemptively detect potential risks of product launch and project failures.

### BACKGROUND

Companies designing and innovating new products often face a myriad of issues and challenges throughout their product design and time-to-market cycles. Initial stages of design can be fraught with conceptual challenges, including defining clear objectives and aligning the design with market needs and technological feasibility. As the product moves into the testing phase, unforeseen technical problems and design flaws may emerge, requiring significant iterations and adjustments. Beta testing with customers introduces another layer of complexity, as real-world use can reveal unanticipated issues and generate diverse user feedback. Balancing this feedback while maintaining the original vision and functionality of the product can be particularly challenging. Furthermore, time constraints and budget limitations often pressure companies to expedite the tweaking and finalization processes, potentially compromising thorough testing and refinement. These cycles demand continuous collaboration, effective communication, and agile problem-solving to navigate successfully and deliver a high-quality product to market.

Further, most products fail in the marketplace, which is another pain point that product innovation companies face. According to various studies and industry reports, the failure rate for new products ranges from around 40% to 95%. Reputable sources that provide failure rates of new products include Clayton Christensen's research at Harvard Business School, Product Development and Management Association (PDMA), Standish Group's CHAOS Reports, Forrester Research, and Gartner.

### BRIEF DESCRIPTION OF THE DRAWINGS

FIG. 1 is a simplified illustration of the innovative concept behind the AI-assisted product innovation and development platform and method upon which the AI-assisted mechanism to realign the product launch plan and preempt product failures in the market may be implemented;

FIG. 2 is a simplified diagram illustrating the main stages of the AI-assisted product innovation and development sequence upon which the AI-assisted mechanism to realign the product launch plan and preempt product failures in the market may be implemented;

FIG. 3 is a simplified workflow diagram of the AI-assisted product innovation and development platform and method upon which the AI-assisted mechanism to realign the product launch plan and preempt product failures in the market may be implemented;

FIG. 4 is a simplified system architecture diagram of the AI-assisted product innovation and development platform and method upon which the AI-assisted mechanism to realign the product launch plan and preempt product failures in the market may be implemented;

FIG. 5 is a more detailed workflow diagram of the AI-assisted product innovation and development platform and method upon which the AI-assisted mechanism to realign the product launch plan and preempt product failures in the market may be implemented;

FIGS. 6 and 7 are simplified flowcharts of the AI-assisted product innovation and development platform and method upon which the AI-assisted mechanism to realign the product launch plan and preempt product failures in the market may be implemented;

FIG. 8 is a simplified workflow diagram of the AI-assisted mechanism to realign the product launch plan and preempt product failures in the market according to the teachings of the present disclosure;

FIG. 9 is a simplified flow diagram of the AI-assisted mechanism to realign the product launch plan and preempt product failures in the market according to the teachings of the present disclosure;

FIGS. 10 and 11 are a simplified flow diagrams of the set up and operational flow diagrams of the data trackers to implement the AI-assisted product failure preemption and product launch plan realignment method according to the teachings of the present disclosure; and

FIG. 12 is a simplified block diagram of the AI-assisted product innovation and development platform and method upon which the AI-assisted mechanism to realign the product launch plan and preempt product failures in the market may be implemented.

### DETAILED DESCRIPTION

The main problem addressed by the AI-powered project risk detection and realignment system and method is the high failure rate of new products in the market. Many products fail to succeed due to a variety of factors, including poor market fit, inadequate understanding of customer needs, ineffective marketing strategies, and intense competition. These failures can result in significant financial losses and wasted resources for companies.

Furthermore, product managers often overlook key external elements such as political, regulatory, and social issues, which can drastically affect the success of a product. During the product development and innovation phases, there are numerous unknowns. Competitors might be developing similar products in secrecy, regulatory changes could be brewing, and political or social issues might arise unexpectedly. These factors can lead to incorrect strategies and decisions if not adequately monitored.

Moreover, once a project is funded and the product development and launch process begins, there tends to be a lack of continuous monitoring of the external environment. While initial market research and environmental scanning are conducted prior to strategy formulation and finalizing product requirements, this vigilance often lapses during the development and go-to-market phases. As a result, companies may miss critical developments such as competitor actions, regulatory hurdles, or political issues, leading to unexpected challenges that can derail the product's success.

Additionally, several specific issues can contribute to product failures: sometimes it is negligence, sometimes it is inadequate research, sometimes it is poor judgment, and sometimes it is mistakes made during the development process. These various reasons, stemming from human error or oversight, further compound the challenges faced in ensuring product success.

Projects often fail due to a combination of internal and external factors. Internally, unclear objectives, inadequate planning, poor communication, and insufficient risk management create a foundation for failure. Resource misallocation, weak stakeholder engagement, and ineffective governance further complicate project execution. Externally, market dynamics, regulatory changes, and evolving customer preferences can disrupt progress. Without effective monitoring, change management, and leadership to address both internal and external factors, projects are prone to delays, budget overruns, and quality issues, ultimately leading to product failures in the market.

Existing technology for product development primarily relies on manual processes and human judgment, which can be subjective and prone to errors. Traditional market research methods, such as surveys and focus groups, often provide limited insights and may not accurately predict product success. Additionally, current quality control measures and customer feedback mechanisms are typically reactive, addressing issues only after they have already impacted the product's performance in the market.

Furthermore, existing technologies do not adequately incorporate continuous monitoring of the external environment, such as political, regulatory, and competitive landscapes, during the entire product development and launch process. Additionally, customer sentiments may evolve and change from the time the product idea is conceived to the time the product is launched. This oversight can result in companies being blindsided by unexpected external factors and shifting customer preferences. The absence of dynamic realignment based on real-time insights from the external environment and evolving customer sentiments can lead to product failures due to inadequate research, poor judgment, negligence, or unforeseen circumstances.

Existing technologies also do not adequately address internal factors such as poor project planning, resource allocation, communication, and stakeholder engagement. Insufficient monitoring, weak governance, and leadership can lead to missed milestones and quality issues. Addressing these internal challenges with continuous monitoring and real-time adjustments is crucial for successful product development and launch.

Current methods also do not leverage the full potential of advanced data analysis and artificial intelligence to provide comprehensive, real-time insights and predictive analytics. These capabilities are essential for guiding product development and marketing strategies more effectively, enabling companies to proactively identify and address potential product failures before they occur.

A particular product space that faces these hurdles is the sporting goods industry. There are significant time-to-market challenges faced in certain industries, such as the sporting goods industry. The sporting goods industry demands rapid innovation to remain competitive, yet short technology cycles strain and limit in-house resources for sporting goods producers that create products, and sports organizers that create compelling experiences for fans through innovative technologies. Short technology cycle refers to the rapid pace at which technology evolves and becomes outdated. In high-velocity industries such as sports engineering/tech, electronics, apparel, and pharmaceuticals, companies face significant pressure to innovate continually. New advancements and innovations are introduced frequently, necessitating constant updates to products and services. This rapid turnover can strain in-house resources, as companies must continuously invest in research and development to keep up with the latest technological trends and remain competitive in the market. The challenge is compounded by the difficulty in accessing external expertise and technologies, which are critical for maintaining a competitive edge in such a fast-paced environment. This often results in delays or market failures for new products and experiences. Additionally, there is a challenge of limited access to external expertise and technologies that are required to create compelling products and experiences. Despite the existence of vast market resources with innovation opportunities, accessing these expert technology providers proves difficult due to the lack of convenient methods and tools. Consequently, there are missed opportunities for innovation and advancement in the fast-paced sporting goods industry.

Existing technology solutions fall short in addressing these challenges adequately. While some platforms focus on matching users with experts, they primarily cater to searching for coaches, facilities, and other resources for training or recreational purposes, lacking a specific focus on technology innovation or product launch. These solutions either provide information on available experts or attempt one-to-one matchmaking, but they do not facilitate the gathering of all resources required for technology innovation or product launch. Moreover, they lack the capability of “expertly matching” and “seamlessly stitching” custom technology innovation or product launch solutions. Furthermore, they lack the capability to orchestrate and guarantee successful market launches through a “supported path.” It should be noted that although the present disclosure is focused on the sporting goods space, the platform and methodology described herein are equally applicable to other industries.

To overcome these limitations, the AI-assisted system and method (also collectively referred to as the platform 100) described herein address the aforementioned challenges and introduce a digital marketplace that empowers sports innovation with a rapid and fully-supported design-to-market path upon which AI-assisted mechanism to realign product launch plan and preempt product failures in the market may be implemented. The platform 100 facilitates the “expertly matching” of “sporting goods producers” and “organizers” (also called the demand side of the marketplace) with “sports technology providers” (the supply side of the marketplace), “seamlessly stitches” tailored market solutions, and enables the rapid launch of products to the market. The term “expertly matching” refers to methodologies that use advanced algorithms and artificial intelligence to analyze the specific needs of a product or innovation request to search for and identify the best-suited experts and resources from both internal and external sources. The term “seamlessly stitching” refers to the platform's ability to bring together different elements—such as experts, technologies, and processes—into a unified, well-coordinated team. This integration ensures smooth collaboration and communication among all parties involved, minimizing disruptions and inefficiencies. This ensures that the selected experts and resources have the relevant skills, knowledge, and experience to contribute effectively to the project's success. The goal is to create a streamlined workflow that facilitates the rapid and effective development and launch of new products. This process provides a “fully-supported path” that includes creating project plans, business plans, contracts, budget requirements, go-to-market plans, and other necessary artifacts. The “fully-supported path” means a guided and structured process that ensures all necessary steps and resources are in place for the successful execution and launch of a product or innovation. This includes continuous support, monitoring, and provision of tools to enhance efficiency, productivity, and risk management. The fully-supported path involves providing a clear roadmap for the product development and launch process. This includes offering tools, resources, and ongoing assistance to navigate each stage of innovation. The platform orchestrates the entire process to save time, accelerate task execution, and minimize risks by identifying potential issues in advance and addressing them proactively. The fully-supported path also encompasses creating and integrating various plans and artifacts, conducting comprehensive research and analysis internally and externally, and automating workflows such as go-to-market plans and contracts. By fostering collaboration, improving productivity, and nurturing the team, the platform ensures that all activities are on track and that the product reaches the market successfully and efficiently. Additionally, the platform adopts a holistic approach by continuously analyzing existing work done by the teams to ensure no aspects are overlooked. This holistic approach includes cross-checking plans with external competitive works and market trends, mitigating the risk of human error and negligence, and ensuring a thorough and comprehensive development process. The platform enables key processes and establishes a collaborative environment and workflow for all stakeholders, both internal and external to the company, to work together to deliver the project/product innovation.

By streamlining the innovation process and providing access to a network of expertise and resources through a holistic approach, the platform aims to revolutionize the sporting goods industry and drive successful product launches.

The AI-assisted product innovation and development platform 100 (also referred to as a product innovation marketplace platform) is a technology platform that enables a marketplace for supply side and demand side to cooperatively work together and ignite innovation in various industries. The platform 100 initially targets the sports-tech industry and enables a product innovation marketplace platform that empowers seamless exploration of cutting-edge sports technology and resources. It identifies and matches sporting goods brands and organizers (sporting goods producers) with sports technology providers to drive collaboration, stitches sport innovation together to create new and exciting products and services and accelerates the launch of differentiated sport innovation for rapid market entry. The platform uses artificial intelligence to dynamically stitch tailored solutions for launch and is a one-stop-shop for easier access to information, technology providers, and resources. The resources can be any person, thing, or entity that can contribute to the project, such as data, software, hardware, tools, equipment, machines, bots, and AI solutions. The platform is a comprehensive platform that not only provides access to resources but also offers a complete suite of tools and services for identifying, matching, and integrating expertise and technologies. This includes orchestrating teamwork and workflows, providing a supported path, creating artifacts based on analysis and research, increasing productivity, accelerating launch, identifying and mitigating risks, and ensuring the success of product innovations and launches. This holistic approach ensures that all necessary steps and resources are in place for the successful execution and launch of product innovations.

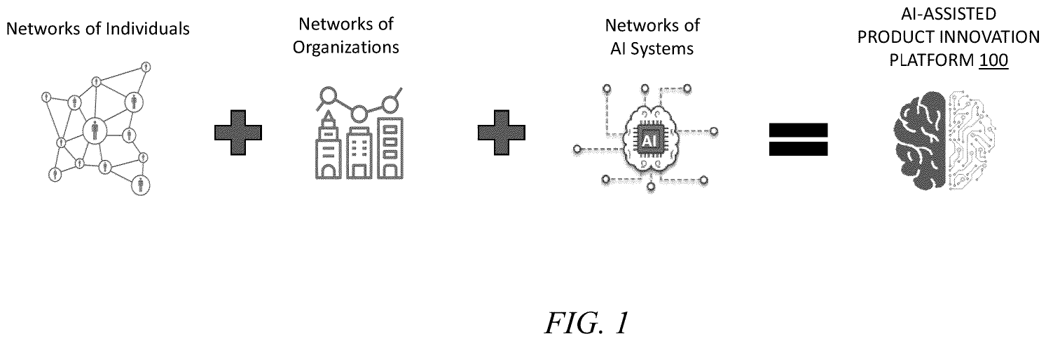

As shown in FIG. 1, the AI-assisted product innovation and development platform 100 stitches together networks of individuals, organizations, and AI systems to enable a product innovation marketplace platform where these entities can work collaboratively to achieve product innovation, implementation, and launch in a rapid and efficient fashion. The platform 100 fulfills a one-stop-shop concept via human+AI collective intelligence and collaboration and bring together demand side (producers and organizers) and supply side (technology providers) entities. The demand side entities include sporting goods companies (existing and aspirational), organizers (e.g., International Olympic Committee (IOC), National Collegiate Athletic Association (NCAA), NFL (National Football League), NBA (National Basketball Association), WNBA (Women's National Basketball Association), MLB (Major League Baseball), NHL (National Hockey League), AHL (American Hockey League), MLS (Major League Soccer), USL (United Soccer League), NWSL (National Women's Soccer League), NASL (North American Soccer League), FIFA (Fédération Internationale de Football Association), PGA (Professional Golfers' Association), LPGA (Ladies Professional Golfers' Association), ATP (Association of Tennis Professionals), WTA (Women's Tennis Association), ITF (International Tennis Federation), USATF (USA Track & Field), USA Cycling, USA Swimming), athletes, sports teams, fans, and sports tech startups. The supply side entities include researchers, engineers, academia, institutions (e.g., Olympics, NCAA, NFL, NBA, WNBA, MLB, NHL, AHL, MLS, USL, NWSL, NASL, FIFA, PGA, LPGA, ATP, WTA, ITF, USATF, USA Cycling, USA Swimming), consultants, labs, and manufacturers.

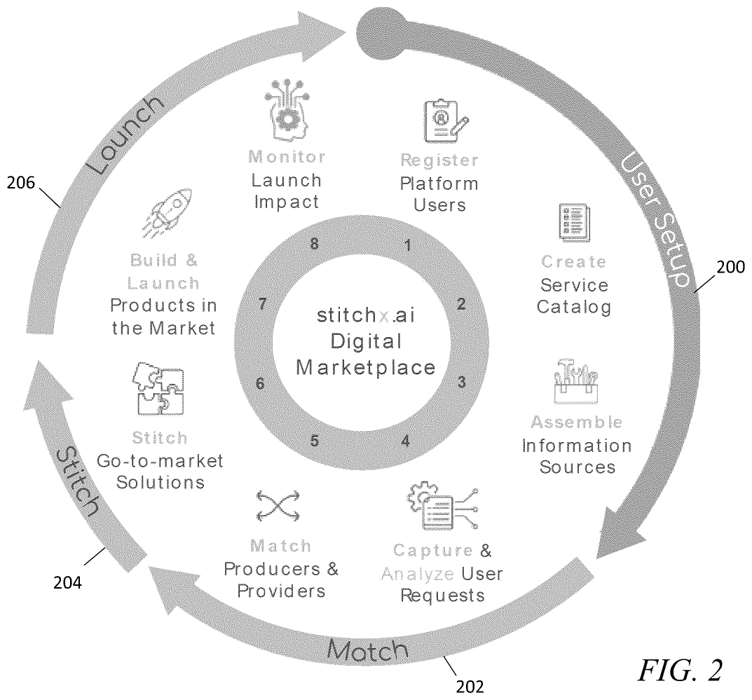

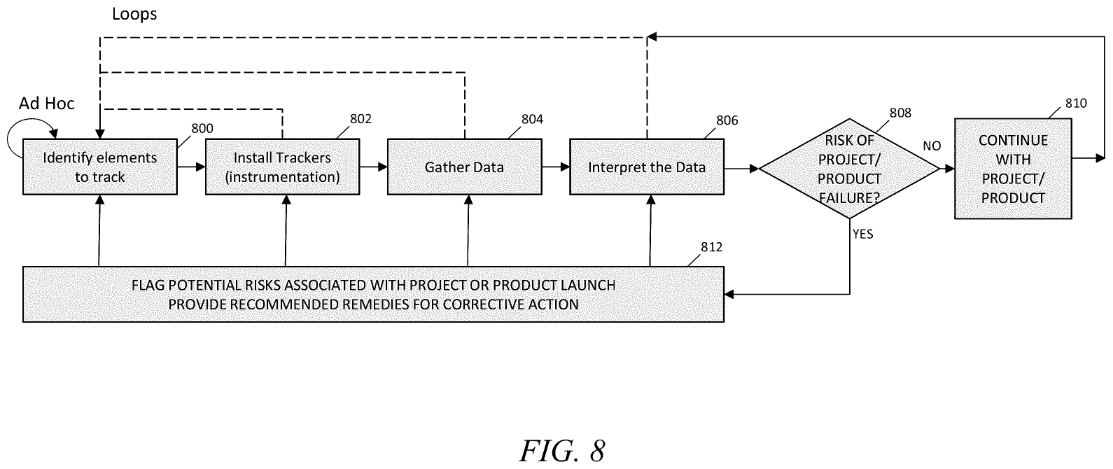

As shown in FIG. 2, the product innovation marketplace platform 100 is a software platform executing in cloud-based servers (see FIG. 8) that uses the latest emerging technologies to enable a range of capabilities such as registering platform users, creating a service catalog, assembling information sources, capturing and analyzing requests from platform users, matching sporting goods brands/producers, stitching and launching product innovations, driving product development and collaboration for launch, and monitoring launch impact.

In the User Setup Phase 200, users from both the demand and supply sides register on the platform, and all relevant information/data from all the users are collected and stored in one or more databases connected to the platform. A product catalog is created for sports technology providers to showcase their offerings.

In the Match phase 202, users from the demand side express their needs or requests through a natural language user interface (e.g., text, images, verbal, gestures). The platform, using AI technology, captures and analyzes these user needs and requests to understand user intentions, particularly regarding the creation of products. Utilizing natural language processing algorithms, the platform identifies the best match of resources from sports technology providers to satisfy user needs or requests. AI algorithms intelligently optimize the searches for resources, exploring both internal and external connections and networks where relationships have been established. In the Match phase, users select entities and resources that are available to them to work on the project.

In the Stitch phase 204, the platform 100 intelligently stitches together a go-to-market plan for the innovation. The Stitch process involves assessing existing user-created plans, analyzing internal factors such as selected resources, and considering external factors like market dynamics to formulate an optimal plan. In order to stitch a launch innovation solution, several components need to be created and integrated: the team, the business plan, the project plan, market research and customer needs-driven product requirements, the budget, etc. The platform 100 first analyzes all the documents and work done by the user (sporting goods producer or organizer), which means that all this information must be uploaded or fed into the system platform, or be accessible by the platform.

In the Launch phase 206, the platform 100 facilitates collaboration between users and selected resources to execute the innovation go-to-market plan. The platform 100 tracks and monitors progress of tasks within the plans, and offers assistance along the plan execution path to ensure project milestones are reached and progression is on track. The platform 100 is configured to track key performance metrics, gather customer feedback, analyze market trends, identify post-launch issues, and use these insights for continuous improvement.

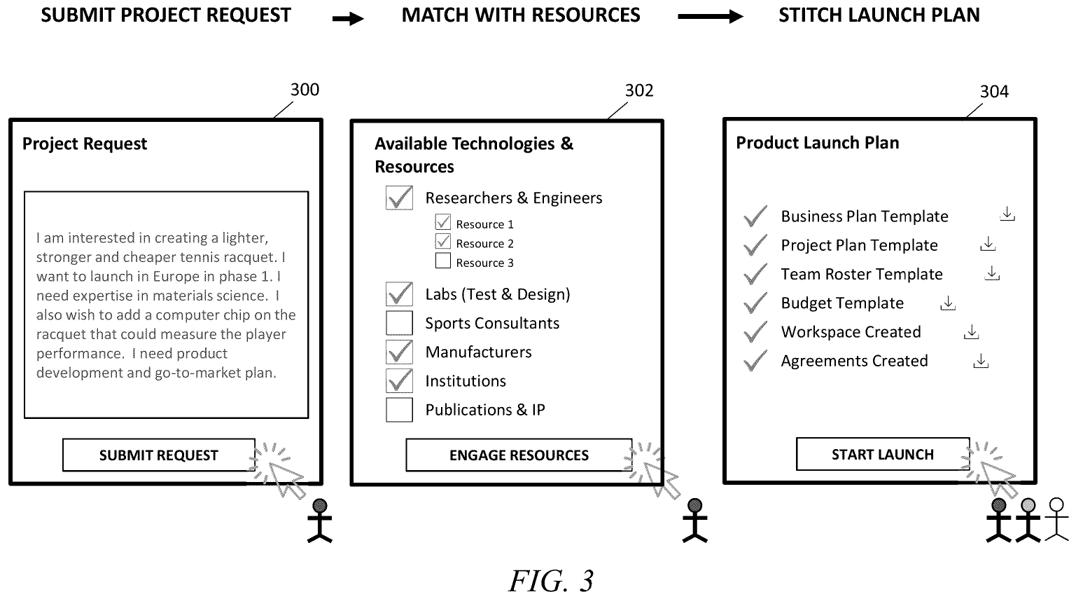

FIG. 3 illustrates how users interact within and on the platform 100. In step 300, a user submits a project request that describes what the user would like to create and take to market. This request may be an input that is in one or combination of data formats, including text, images, graphics, sketches, spoken words, and audio data. In step 302, the user is presented with available technologies and resources along the entire product development path from conception to market. The platform 100 may provide additional information and resources to aid the user in making these selections. The user selects and engages the available resources in step 302. In step 304, the product launch plan is designed and put in place, including facilitating the execution of legal contracts among the parties.

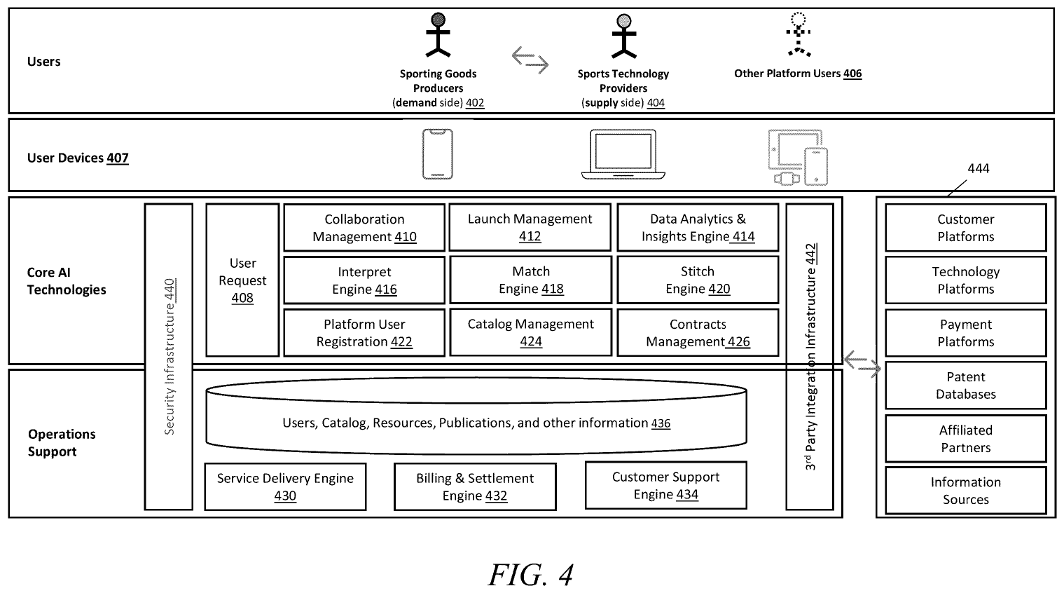

FIG. 4 is a simplified diagram that illustrates an overview of the platform architecture, showcasing the foundational components essential for facilitating the marketplace's match, stitch, and launch processes. It demonstrates the platform's accessibility by demand side users 402, supply side users 404, and other users 406 across various devices 407 and its capability for seamless integration with external platforms. The platform's core technology includes modules that enable the conception to marketplace execution by enabling and performing user request 408, collaboration management 410, launch management 412, data analytics & insights engine 414, interpret engine 416, match engine 418, stitch engine 420, platform user registration 422, catalog management 424, and contracts management 426. The platform user registration 422 enables users from both the demand and supply groups to register onto the platform 100, including querying, receiving, and storing information about their expertise, resources, and needs. The user request module 408 enables demand side users to submit requests for specific products or innovations, outlining their requirements and preferences. The AI-assisted match engine 418 utilizes AI algorithms to search and identify suitable expertise and resources from the registered platform database and external sources, matching them with the submitted requests. The AI-assisted stitch engine 420 orchestrates the assembly of a cohesive team along with the go-to-market plan to facilitate the launch of the product. The AI-assisted collaboration management engine 410 manages the collaboration process between users, ensuring seamless communication and coordination throughout the innovation lifecycle. The AI-assisted launch management engine 412 oversees the product launch process, providing support and monitoring progress to ensure successful market entry.

The platform 100 also includes operations support capabilities, including service delivery engine 430, billing & settlement engine 432, customer support engine 434, and one or more databases 436 that store data related to users, catalogs, resources, publications, etc. A security infrastructure 440 and third-party integration infrastructure 442 span both the core AI technologies and operations support layers of the platform architecture. The third-party integration infrastructure 442 enables seamless connection and communications with entities 444 such as customer platforms, technology platforms, payment platforms, patent databases (e.g., United States Patent and Trademark Office databases), affiliated partners, and information sources (e.g. research and academia publications and libraries).

These platform components work together seamlessly to address the preexisting problem of time-to-market hurdles and limited access to external expertise and technologies in the sports innovation industry. By enabling efficient resource matching, collaboration, and launch management, the platform 100 streamlines the innovation process, accelerates product development, and ensures timely market entry. The AI algorithms optimize resource allocation and provide many other critical functionalities, ensuring that users are connected with the most suitable experts and resources to meet their specific needs and have a fully-supported launch plan to reach market launch.

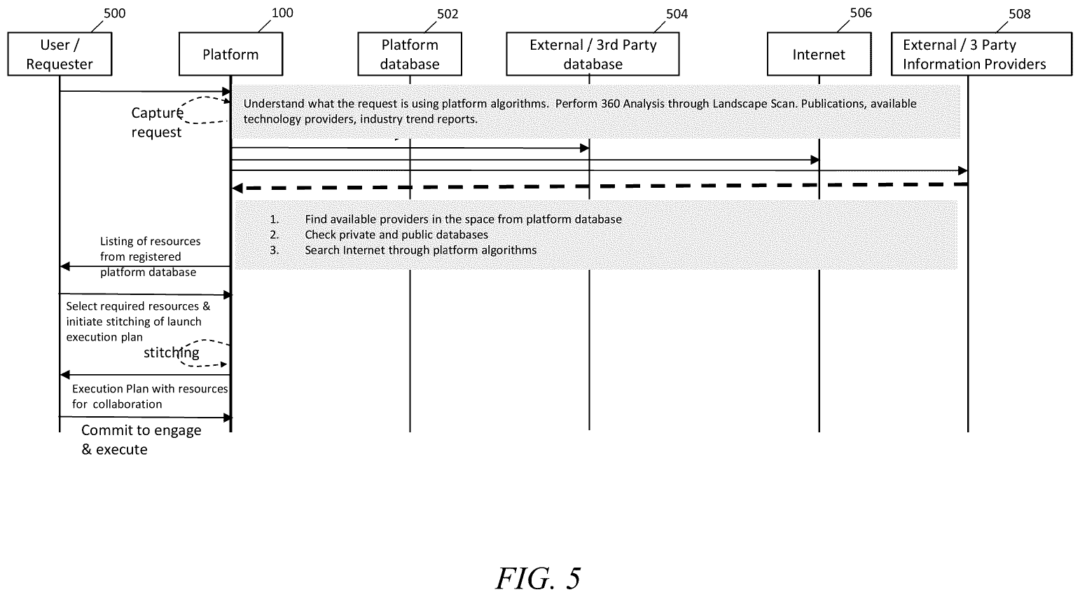

FIG. 5 is a sequence diagram that illustrates the interactions between users 500 and the platform 100. Initially, the user submits a request, which the platform 100 captures and analyzes to comprehend the innovation. Subsequently, the platform 100 conducts a thorough search for resources both internally (in its own databases 502) and externally (external databases 504 and information providers 508 via the Internet 506), generating results. Users 500 can then select the most suitable resources and initiate the stitching of a launch plan. Finally, the platform 100 orchestrates and manages the launch process, facilitating and monitoring collaboration between users and resources.

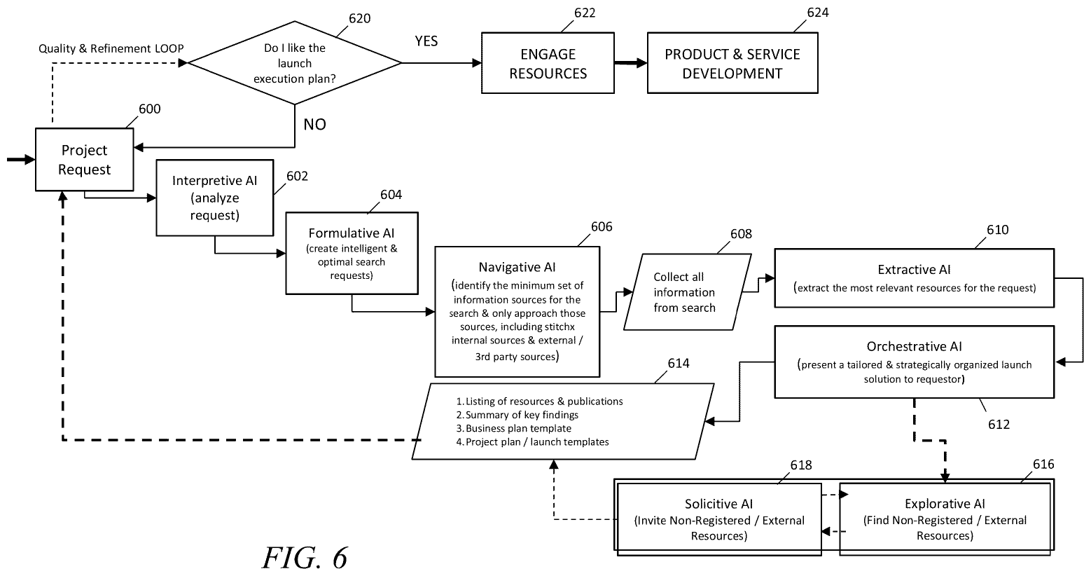

FIG. 6 illustrates how each AI algorithm is triggered and executed in a sequence. The user's request 600 submitted to the platform 100 triggers an interpretive AI module 602 to analyze the user requests, interpreting the underlying innovation or product requirements. The output from interpretive AI 602 is provided to or accessed by a formulative AI module 604, which includes an advanced AI algorithm designed to generate intelligent and optimized search queries based on user inputs or requests. This algorithm formulates search queries in a way that maximizes the likelihood of retrieving relevant and valuable information or resources from various sources. By analyzing the context and requirements of the user's request, formulative AI 604 dynamically generates search queries tailored to specific needs, leading to more accurate and efficient search results. Navigative AI 606 then identifies the minimum set of information sources necessary for conducting searches, including both internal sources within the platform 100 and external third-party sources. It also streamlines the search process by focusing on relevant sources only. All of the research results are collected (block 608) and stored. An extractive AI module 610 then extracts the most relevant resources from the search results obtained through navigative AI 606, ensuring that only the most suitable resources are presented to the user. An orchestrative AI module 612 is responsible for generating and presenting tailored and strategically organized launch solutions to the users based on their requests. It synthesizes the selected resources into a cohesive and comprehensive launch (concept-to-market) plan 614 and orchestrates the execution process. The launch plan 614 includes a list of relevant and recommended resources and publications, a summary of key findings, pre-completed business plans, project plans, and go-to-market plans with launch templates. These documents are designed to be more than just basic templates; they have a substantial portion of the content pre-populated by AI. By providing plans with a substantial portion of the content pre-populated by AI, the platform significantly reduces the time required for planning. Users do not have to start from scratch, which accelerates the development and launch process by several months. This pre-completion is achieved through advanced AI algorithms that analyze the user's inputs, existing documents, market data, and best practices to generate comprehensive plans tailored to the specific project requirements. The business plans, project plans, and go-to-market plans provided by the platform are not empty templates but are filled with relevant data, insights, and structured information. This includes market analysis, competitive landscape, budget estimates, timelines, risk assessments, and strategic objectives. Advanced AI algorithms analyze various data points such as user inputs, existing plans, market trends, and historical data to pre-complete these documents. This process ensures that the plans are contextually accurate and highly relevant to the specific needs of the project. Although the documents are largely complete, they are designed with room for human intervention. Users can step in to review, correct, and finalize these documents. This ensures that the plans are not only comprehensive but also customized to meet specific nuances and requirements that might not be fully captured by the AI. Once users have made necessary adjustments, they can finalize and approve the documents for use. This collaborative approach ensures that the final plans are thorough, accurate, and ready for implementation. The pre-completed documents take a holistic approach by integrating various aspects of the project, such as resource allocation, risk management, and market strategies. This comprehensive planning ensures that all critical factors are considered and addressed.

If the platform identifies non-registered resources as a valuable resource for the project because these resources were not available within the platform database, then the platform will attempt to explore, identify, and shortlist non-registered resources. An explorative AI module 616 is tasked with finding and shortlisting non-registered or external resources that match the user's needs. It explores various channels and databases to identify potential resources for solicitation. Once potential resources are identified, a solicitive AI module 618 takes the initiative to contact and invite these non-registered or external entities/resources to register and become part of the platform. It facilitates the expansion of the platform's network and resource pool.

Upon presentation of the launch plan, the user may ask the platform iteratively to refine and regenerate the launch plan if the user is not satisfied with the presented plan (block 620). The user may tweak or modify their request so that the platform 100 may better understand the request. If the user likes the presented launch plan, then the user proceeds to engage with the entities and resources in the plan, assisted by the platform 100, and proceed with product design and development to market.

As part of the platform's process depicted in FIG. 6, the platform 100 also employs machine learning techniques to continuously refine and update its dynamic knowledge base or learned model. As the platform 100 acquires new information, it adjusts its various parameters to improve its performance. This process, known as “training” or “fine-tuning,” involves updating the database or model with new data to enhance its accuracy in making predictions, recommendations, and/or decisions. The database or model is a structured representation of the system's knowledge, enabling it to adapt and make informed choices when presented with new input. At every step of the algorithm progression, the system continuously updates its knowledge or model.

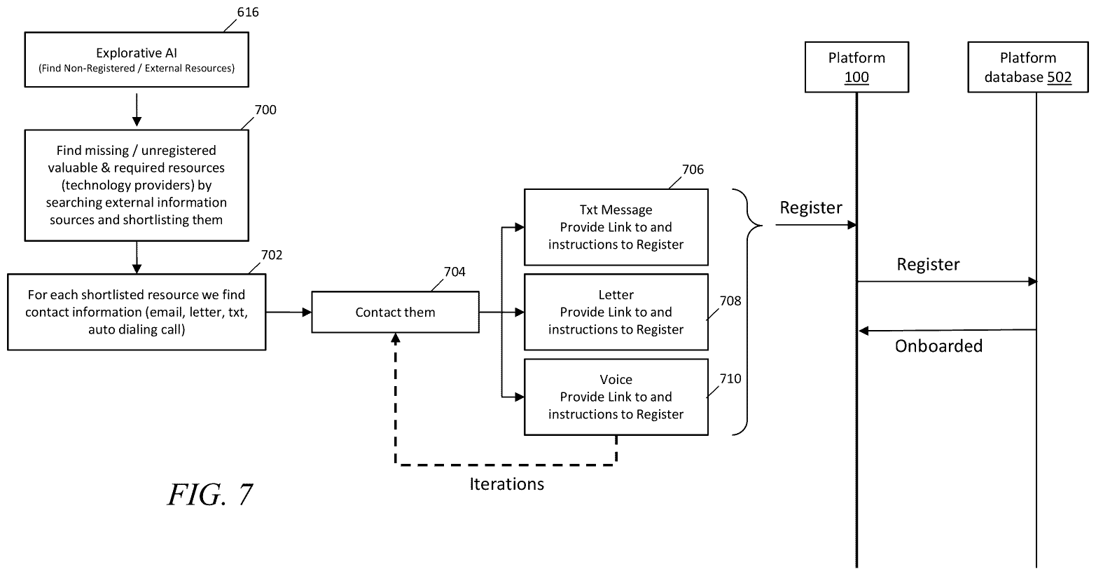

FIG. 7 is a flowchart of the explorative AI module 616 methodology. Explorative AI is tasked with identifying missing or unregistered valuable and required resources, particularly technology providers, by conducting searches across external information sources. Once potential resources are identified, the AI shortlists them based on relevance and suitability for the platform (700). For each shortlisted resource, Explorative AI gathers contact information, including email addresses, postal addresses, phone numbers, and other relevant details (702). Subsequently, the AI initiates contact with these potential resources (704) through various means such as email, physical mail, text messages, and/or automated phone calls, inviting them to register and become part of the platform (706-710). The methods of contact automatically include means for the contacted entity/resource to register with the platform. For example, the method could include a link/URL that the resources can click on, or it could include a Quick Response (QR) codes that can be scanned, etc. When the link is clicked or QR code is scanned, the process of platform registration gets initiated. Once these entities/resources are registered with the platform, they are onboarded to be part of the available resources that can be incorporated within launch plans offered to the users who submit requests.

The system and method of AI-assisted mechanism to realign project implementation and preempt product launch failure in the market by leveraging AI technology to spot vulnerabilities and anticipate failures so that systematic remedies may be proactively implemented. It employs foresight so that preventative actions are taken ahead of time. Factors that may adversely affect the success of a product include the internal world, i.e., the company, the team, and the product launch plan, and the external world into which the product will be launched. The team encompasses endogenous factors such as project scope, team members, team tasks, and internal company activities. The company encompasses exogenous elements such as functions, managers, and executives that impact the team. As part of the internal world, the innermost zone is the business, i.e., the core operations and activities within the company. The company's business functions around the inner core business include the company's research and development, operations, finances, marketing/sales, and management. Further, the product launch plan may also have vulnerabilities, such as adequacy of the budget, resources, or timeline. Beyond the internal world, the external world includes stakeholders and forces outside the company, such as vendors, partners, customers, competitors, and other external elements. The external world also includes the economy, the legal landscape, the competition, the technology or state of the art landscape, social environment, and the global environment. These external factors must be continuously monitored to understand their impact on the business and the product. AI technology is used to track these environments to ensure that the product does not fail in the market. Market failure is defined as an inefficient distribution of goods and services in the free market. This inefficiency can be caused by various internal and external factors that preemptive AI aims to identify and address proactively.

There are a number of reasons why projects fail. These include a lack of clear project objectives and goals, inadequate project planning and estimation (e.g., time, resources, and costs), poor communication, coordination, and collaboration among team members and stakeholders, scope creep beyond the original project/task specifications or requirements, lack of stakeholder engagement and support, inadequate risk management, poor resource (personnel, budget, equipment, etc.) allocation, insufficient project monitoring and control, lack of change management, and inadequate project governance and leadership.

The platform 100 incorporates the capability to spot risks associated with a project or a product launch plan by using a combination of data collection, interpretation, analysis, and decision-making processes driven by AI technologies. Here is a high-level description of the operating principle:

1. Data Collection: Internally, data trackers are installed at various points along the product launch pipeline to gather relevant data and insights that may be used to detect project or product launch plan vulnerabilities or areas of concern. Externally, relevant data from various external sources, such as market research reports, customer feedback, social media, competitor analysis, economic indicators, and legal databases, are collected and integrated into a centralized system. Electronic data interchanges (EDIs), application programming interfaces (APIs), and other data feeds and data channels can be established to automatically receive and access real-time data or periodically into the system for analysis. The data trackers can be automatically and continually added, removed, and tweaked to update or change the data that they receive/collect via a feedback loop or by authorized administrator control. The data trackers are also referred to as “trackers” and “virtual sensors” in the present disclosure. The data trackers include localized intelligence (e.g., AI) to aid in the gathering of data and insights.

2. Data Processing and Analysis: AI algorithms process, interpret, and analyze the collected data using techniques like natural language processing, machine learning, predictive modeling, and data mining. Patterns, trends, and correlations are identified to gain insights into potential risk factors and indicators of product failure or product launch plan going off-track.

3. Risk Assessment and Prediction: Based on the analyzed data, AI algorithms assess the probability of risk by considering a wide range of internal and external factors. These factors are weighted and evaluated to generate a risk score or probability estimate for each product/project.

4. Early Warning System and Alerts: The system generates real-time alerts and notifications to product managers when potential risks or vulnerabilities are detected. The platform 100 can send instant notifications to project stakeholders via email, SMS, or through a dedicated project management tool. This ensures that stakeholders are promptly informed about the detected vulnerabilities. The platform 100 also displays alerts on a centralized project dashboard or management tool, highlighting the specific vulnerabilities and their potential impact on the project. This allows stakeholders to easily access and review the information. This allows for timely intervention and proactive measures to address identified issues and prevent failures. The system can generate automated reports detailing the detected vulnerabilities, their severity, and recommended actions. These reports can be scheduled or triggered based on specific thresholds or milestones, ensuring stakeholders have up-to-date information. In critical situations or high-risk vulnerabilities, the system can implement an escalation mechanism that automatically notifies higher-level stakeholders or project sponsors. This ensures that appropriate attention is given to urgent vulnerabilities.

5. Decision Support and Recommendations: AI provides product managers with actionable insights, recommendations, and alternative strategies to maximize the success of products. This includes suggestions for marketing campaigns, pricing adjustments, feature enhancements, target audience optimization, and competitive positioning. Comprehensive information is provided to stakeholders to enable and empower informed decision-making regarding product launch plan realignment, such as resource acquisition and allocation, task prioritization, job reassignment, revising timelines, obtain additional funding, and other risk mitigation strategies.

6. Collaboration & Communication Tools: The platform provides visual representations of vulnerabilities through interactive dashboards, highlighting critical areas or trends. This allows stakeholders to quickly grasp the overall project health and focus on key vulnerabilities. The platform includes project management tools where stakeholders can discuss and address the identified vulnerabilities. This facilitates communication, coordination, and timely resolution of issues. If stakeholders are frequently on the move, the system can provide a dedicated mobile application that delivers vulnerability alerts and allows stakeholders to take immediate actions or provide feedback.

Accordingly, the platform 100 is capable of preemptively identify potential risks associated with a project or a product launch so that the teams can be informed to take corrective actions to steer the project/product launch back on track. The platform 100 provides actionable insights and recommendations to address any identified issues. The platform 100 further automatically monitors that the recommended actions are chosen and efforts are being made to realize the recommended actions.

FIG. 8 is a simplified flowchart of an AI-assisted mechanism integral to the platform 100 to detect risks associated with a project or product launch failure in the market by identifying and assessing risks preemptively. The platform 100 is an advanced system designed to ensure projects stay on track and product launches in the market are successful through the use of virtual sensors and trackers. These components work together to continuously collect data to enable the platform 100 to interpret and analyze the data to identify risks. Once detected, proactive corrective actions can be implemented to address potential failures. In steps 800 and 802, internal and external environmental elements are identified for monitoring and tracking. During the product development and launch process, the product development team can dynamically and randomly decide to track new aspects of the product development/launch path as and when needed. The intention is to track more and collect additional data to maximize the product's success in the market. Trackers or virtual sensors are strategically placed at every stage of the launch pipeline and in various key internal and external environments (e.g., product launch plan, budget and resource allocation, legal, technological, global, social, competitive, economic, and other relevant environments), each equipped with unique capabilities, parameters, attributes, and functionalities. For example, these trackers can detect changes in market trends and conditions, as well as anomalies such as deviations from product specifications, lack of focus on critical market activities, or overly ambitious goals that cannot be achieved within the given timeframe. The trackers may also continuously monitor changes in market trends and customer preferences to ensure the product remains relevant. Trackers are also in place to monitor competitor activities and strategies to identify potential threats and opportunities. Trackers also monitor legal and regulatory updates to ensure compliance and avoid potential legal pitfalls. Trackers are also in position to keep track of advancements in technology that could impact the product's performance or market positioning. Trackers are used to monitor and analyze economic trends that could affect consumer purchasing power and product demand. Changes in social and cultural norms that could influence product acceptance and success are also observed and recorded. Global events and their potential impact on the market and product distribution are also monitored. The trackers also obtain data used for sentiment analysis to analyze customer feedback, reviews, social media posts, and other communication sources to gauge public sentiment and perception of the product. Sentiment analysis is used to identify affective states and subjective information through natural language processing, text analysis, computational linguistics, and biometrics. Trackers also follow environmental and sustainability trends to align the product with market expectations for eco-friendly and sustainable products. The ultimate goal is to ensure that the product development and launch process remains aligned with market conditions, maximizing the probability of success and preempting any potential failures.

The virtual trackers monitor and follow both endogenous factors (e.g., product features, marketing strategies) and exogenous factors (e.g., market conditions, external forces such as competitors, customers, and regulatory bodies) and the platform 100 systematically collects data from these trackers (step 804) to provide a comprehensive view of the product's health and alignment with all of these factors. These data collected by the trackers are analyzed and interpreted using AI technologies and other methodologies (step 806) to determine if they point to project/product failure (step 808). If a risk of project/product failure is not detected then the product development/launch continues down the original path (step 810). However, if an internal or external risk has been detected, then the potential risk is flagged (step 812) and all relevant information, including the triggering data and recommended remedies, are provided to the product/project team so that corrective action may be taken. Using such information, the company may take corrective action to realign the project and steer away from the predicted failure. The loops in the diagram indicate a continuous process of gathering data, analyzing data, and making determinations of whether the product is aligned with market conditions and other factors. If any potential issues are detected, a realignment and adaptation process is activated. During this effort, there may be a recognition that additional environmental factors need to be tracked, thus prompting the installation of more trackers where needed to ensure comprehensive monitoring and proactive adjustments. By embedding these virtual sensors throughout the product development and launch pipeline and across different environments, we ensure a proactive and dynamic approach to monitoring and managing both internal and external factors. This method maximizes the probability of product success in the market by continuously adapting to changing conditions and preemptively addressing potential issues.

The proposed system and method implement an AI-assisted preemptive product failure mechanism is superior over existing solutions. The use of AI algorithms and advanced data analysis techniques to proactively detect the probability of product failure in the market is a novel approach. It combines the power of artificial intelligence, big data analytics, and machine learning to provide insights and predictions that were not previously possible using traditional methods. Some of the unique features include:

1. Comprehensive Risk Assessment: The platform 100 considers a wide range of factors, both internal (project/product team, company, management, project plan) and external (outside world), that can contribute to project derailment or product launch failure in the market. Internally, it deploys data trackers/sensors to monitor the progress of the project and predicts points where the project may be going off-track. Project factors taken into consideration include budget, resources, personnel, timeline, milestones, project plan, project management, product launch plan, etc. For potential product failure in the market, the platform 100 deploys trackers/sensors to gather data and intelligence on market trends, competitor activities, consumer preferences, economic indicators, and legal regulations, among other relevant parameters. This comprehensive risk assessment provides a more holistic view of potential risks and helps in developing effective mitigation strategies.

2. Proactive Monitoring and Early Detection: The concept emphasizes continuous monitoring of the market landscape, allowing for early detection of emerging risks and vulnerabilities. By leveraging AI algorithms to analyze real-time data, it enables product managers to identify potential failures before they occur. This proactive approach gives them a competitive advantage and the opportunity to take timely actions to prevent or minimize the impact of failures.

3. Data-driven Decision Making: The concept utilizes advanced data analysis techniques to process and analyze large volumes of data from various sources. By deriving insights and patterns from this data, it empowers product managers to make informed decisions based on objective information rather than relying solely on intuition or experience. This data-driven decision-making approach increases the likelihood of success and reduces the risk of product failures.

4. Adaptability and Agility: The concept acknowledges the dynamic nature of the market and the need for adaptability. It continuously monitors market trends, consumer behaviors, and other relevant factors, allowing product managers to quickly adapt their strategies and make necessary adjustments. This agility helps them stay ahead of the competition and respond effectively to changing market conditions, reducing the likelihood of product failures.

Based on the risk intelligence and insights, the platform 100 detects if a projects is headed in the wrong direction and takes action to realign the project execution to prevent delays, additional expenses, or a jeopardy situation using AI algorithms. The platform 100 analyzes resource utilization and identifies areas where resources are over-allocated or under-utilized. It makes recommendations to adjust resource assignments to ensure optimal utilization and prevent bottlenecks or shortages. The platform 100 monitors project expenses and compare them against the allocated budget. If potential cost overruns or budget deviations are detected, it can trigger alerts and provide recommendations to control costs and align the project with financial constraints. Based on historical project data and risk analysis, the platform 100 proactively identifies potential risks and recommends preventive measures. It provides early warnings and suggests risk mitigation strategies to minimize the impact of risks on project outcomes. Based on real-time data and risk assessments, the platform 100 dynamically reprioritizes project tasks. It identifies critical tasks that are at risk of delay and adjusts the project schedule to focus resources and efforts on those tasks. The platform 100 leverages agile project management principles and make iterative planning adjustments. It continuously evaluates project progress, feedback, and emerging risks to adapt the project plan and adjust priorities, ensuring that the project stays aligned with changing circumstances. The platform 100 further facilitates collaboration and communication among project stakeholders. It provides a centralized platform where stakeholders can discuss identified vulnerabilities, propose solutions, and coordinate efforts to address them, ensuring timely and effective decision-making. A human-in-the-loop approach is implemented to make sure that critical decisions are verified first before implementation, or decisions that are made are communicated to the stakeholders for information, alignment, and further action.

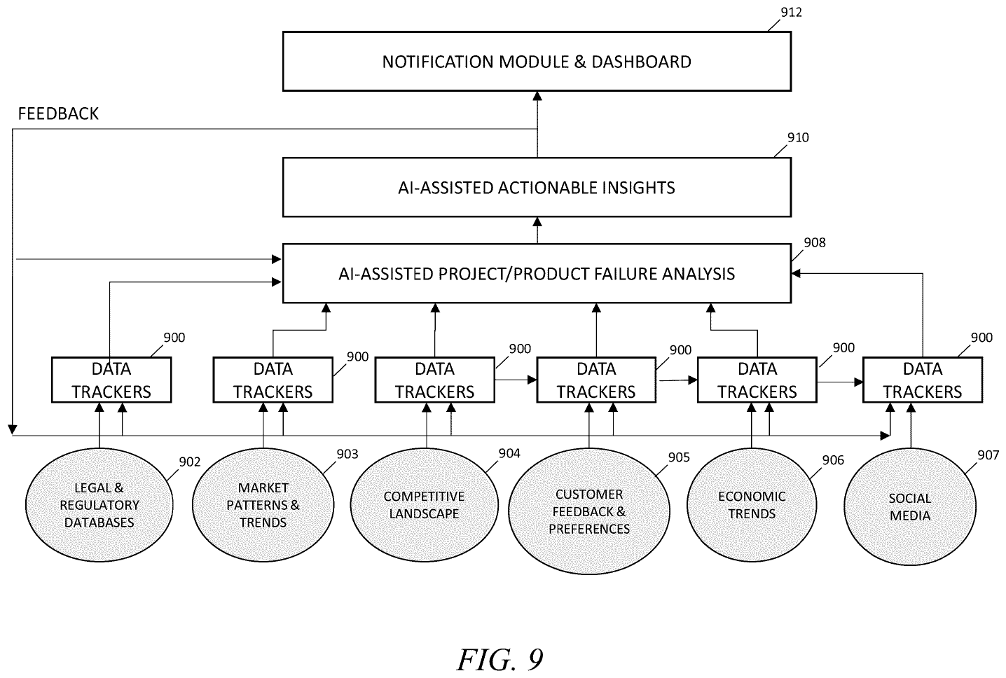

FIG. 9 is a more detailed flow diagram of the AI-assisted mechanism to preempt product failure in the market for the platform 100 described herein. A plurality of data trackers 900 are put in position to collect data from a plurality of sources, for example, legal & regulatory databases 902, market patterns & trends 903, competitive landscape 904, customer feedback & preferences 905, economic trends 906, and social media 907. Examples of other internal environment sources not explicitly shown in FIG. 9 include project plan, project team, stakeholders/partners, budget, project dependencies, scope changes, and unexpected events. These internal and external environmental data sources represent internal and external environmental factors that would impact the product development and launch. The trackers 900 may include AI technology to enable the trackers to discern which data to keep for analysis and which data to discard. The collected data are provided to an AI-assisted product failure analysis module 908 that is able to understand and interpret the data and predictively anticipate a potential risk of failure associated with the product development and launch. The AI-assisted analysis may include pattern detection to identify patterns, trends, anomalies, and changes. The analysis evaluates the likelihood of product failure and potential impact of the detected patterns and trends, and provide actionable recommendations for course correction. The output from the analysis module 908 is provided to an AI-assisted actionable insights module 910 that is able to determine corrective remedies to address the potential risk of failure. These actionable items are provided as output to a notification module & dashboard 912 that is able to present real-time data and periodic reports with executive summary about the risk and actionable items along with all relevant data to the product development/launch team and other stakeholders. The notification module & dashboard 912 may generate and send alerts and status updates to specified stakeholders and provide responses to inquiries posed by the team members and other stakeholders regarding the collected data, detected trends, the risk or other impact on the product launch path, and corrective actions. The AI-assisted actionable insights module 910 is capable of providing feedback to the data trackers 900 and the AI-assisted product failure analysis module 908 to further improve and enhance the understanding of the collected data and make changes to the sources of collected data. The ultimate goal is to precisely identify the sources of potential failures and establish accountability while providing a supportive mechanism to fast-track product launch and achieve success in the market.

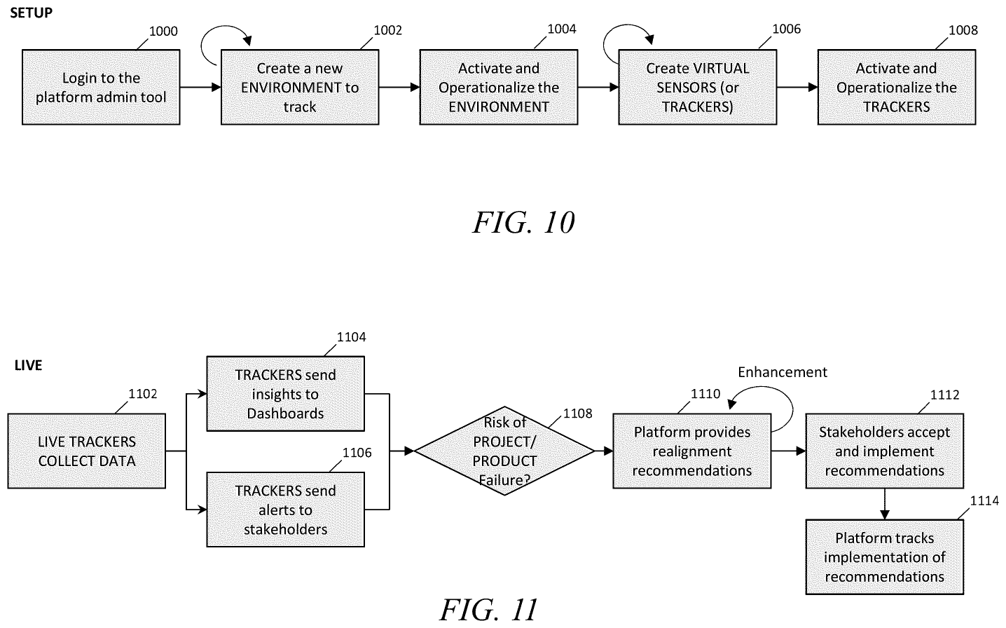

FIG. 10 is a flowchart that illustrates the set up process for the trackers used to monitor internal and external environmental factors that would impact product development and launch. The platform allows project/product managers and/or administrators to login to the tracker admin tool via a secure login interface (step 1000) and provide them the ability to create new environments for tracking specific data types (step 1002). The environments are areas for monitoring specific types of data or conditions relevant to an aspect of the product being developed/launched. Environments can interact with other environments to share data and insights. Localized intelligence gathering and decision-making within the environment are enabled. The created environments can then be activated and made operational (step 1004). The virtual sensors/trackers are created for each newly created environment (step 1006). This includes defining parameters such as type of data to be collected, how frequently the data collection is made, etc. The trackers are activated and made operational (deployed) so that they may collect specific data (step 1008). The trackers also have intelligent capabilities to make localized decisions based on localized interpretation and analysis of the collected data. The data trackers may even share data among themselves to collaboratively analyze the data and make decisions. The administration tool can be used to revise or update the trackers and environments to change their roles and behaviors, as well as removing them from the project/product path.

FIG. 11 is a flowchart that illustrates the operational aspects of the data trackers. The deployed data trackers actively collect data on a periodic or real-time basis, form localized insights, generate alerts (if appropriate), and send them to the dashboard or directly as notification to the stakeholders (steps 1102-1106). The collected data are continually evaluated and analyzed for a risk of project/product failure (step 1108). If a risk is detected, the platform 100 provides proactive realignment recommendations (step 1110). The platform 100 may receive feedback from the stakeholders and/or continually improve and update its recommendations based on real-time data. The stakeholders may accept and implement the recommendations (step 1112). The platform then tracks the implementation of the recommendations to ensure the effectiveness of the implemented measures (step 1114). Using the trackers, the platform continuously monitors the product's status, using AI to detect risks and provide realignment recommendations. Stakeholders are kept informed and can act on these insights to ensure the product remains aligned with market conditions.

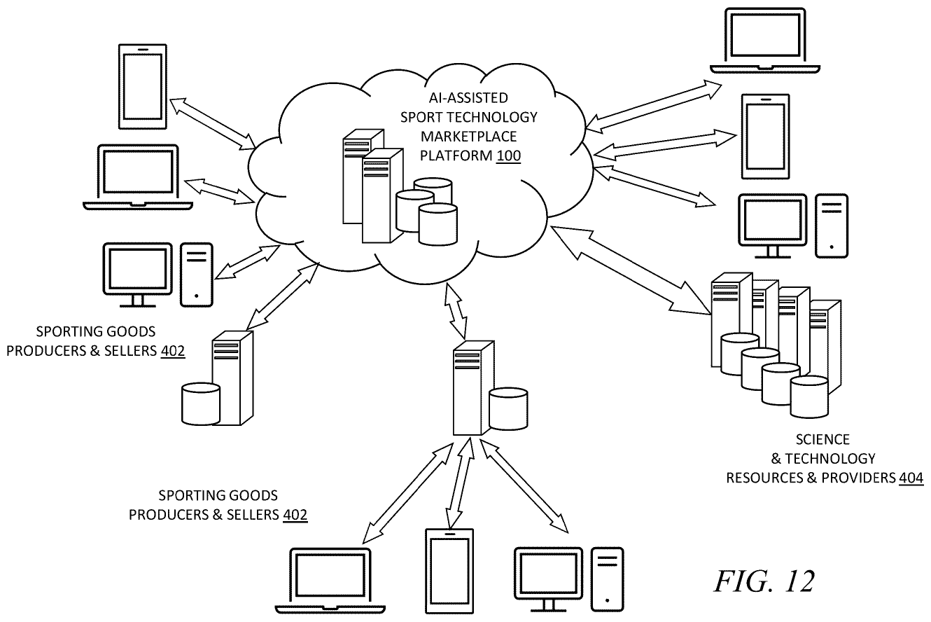

FIG. 12 is a simplified block diagram of the platform ecosystem. The AI-assisted platform 100 described herein provides a digital innovation infrastructure that empowers rapid and expert-led innovation from concept to the marketplace. The AI-assisted platform 100 facilitates the matching of “sporting goods producers” and “organizers” (also called the demand side of the marketplace) 402 with “sports technology providers” (the supply side of the marketplace) 404, seamlessly stitches tailored market solutions, and enables the rapid launch of products to the market. By streamlining the innovation process and providing access to a network of expertise and resources through a holistic approach, the platform aims to revolutionize the sporting goods industry and drive successful product launches. The platform 100 offers several advantages over existing technologies. Unlike conventional solutions that focus on one-to-one matchmaking or provide generic search results, the platform 100 offers a holistic approach by integrating AI algorithms to analyze user requests, match them with relevant expertise, stitch together tailored launch solutions, and provide a fully-supported mechanism to launch the products in the market successfully. This comprehensive approach ensures that users have access to a diverse network of experts, resources, and execution plans, resulting in faster innovation cycles and successful market launches. By being the first to market, the platform secures a first-mover advantage, positioning itself as the pioneering solution in the industry. Secondly, the platform's one-stop-shop approach saves valuable time and resources by providing all necessary tools and resources in a single platform, thereby streamlining the innovation process. Thirdly, the platform's user-friendly interface and intuitive three-step process—match, stitch, launch—ensure simplicity and ease of use for all stakeholders involved. Finally, the incorporation of AI-assisted intelligence expedites the journey to product launch, enabling rapid innovation and market entry.

An example use cases is a sporting goods company seeking to develop a new line of smart athletic wear. A sporting goods company uses the platform 100 to create a new line of smart athletic wear by connecting with experts in wearable technology and materials science. The platform facilitates collaboration with professional athletes, including those not yet registered, who provide critical feedback on performance and design. The platform 100 also delivers pre-completed business and project plans that have substantial portions of the content pre-populated by AI, allowing the company to quickly finalize these documents and execute the project efficiently, thus accelerating the product launch by several months.

Another example is a sports event organizer that uses the platform 100 to enhance the fan experience through augmented reality (AR) technology by connecting with AR developers, content creators, and event management experts. The platform solicits feedback from fans, including those not yet registered, to ensure the AR features are engaging and relevant. The platform 100 provides pre-completed go-to-market plans that have substantial portions of the content pre-populated by AI, enabling the organizer to swiftly finalize and execute the project, ensuring a timely and successful launch of the AR-enhanced event.

The platform 100 also enables demand side users a viable option to outsource expertise and capabilities rather than maintaining in-house personnel and experts for product innovation. The solution offered by the platform 100 is comprehensive and cohesive that can be easily adopted and integrated by the user into its workflow through 3^{rd} party integration infrastructure APIs 442.

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

What is claimed is:

1. An AI-assisted project risk detection system comprising:
a plurality of data trackers configured to automatically collect relevant data associated with a project, the relevant data being selected from the group consisting of project scope, project tasks, project management, project risks, project quality, budget, resources, resource allocation, project team members, project team communications, project milestones, project timeline, project status, product launch plan, market trends, economic trends, competitive landscape, legal and regulatory environment, consumer behavior, consumer preferences, customer feedback, and social media;
an AI-assisted data analysis module configured to receive the relevant data collected by the data trackers, analyze the relevant data, identify emerging vulnerabilities and issues associated with the project, and determine corrective recommendations; and
a real-time notification module configured to generate and transmit notification messages to project team members and stakeholders regarding the identified vulnerabilities, issues, and the corrective recommendations.

2. The AI-assisted project risk detection system of claim 1, further comprising a real-time dashboard module configured to provide a visual interface to project team members and stakeholders regarding the identified vulnerabilities, issues, and the corrective recommendations.

3. The AI-assisted project risk detection system of claim 1, further comprising a report module configured to generate and provide detailed reports regarding the identified vulnerabilities, issues, and corrective recommendations.

4. The AI-assisted project risk detection system of claim 1, further comprising an escalation module configured to automatically generate and transmit high-level risk notification messages to high-level project members and stakeholders regarding high-level identified vulnerabilities, issues, and corrective recommendations.

5. The AI-assisted project risk detection system of claim 1, further comprising a corrective realization module configured to automatically monitor and assure the corrective recommended actions are being implemented.

6. The AI-assisted project risk detection system of claim 1, wherein the data trackers are implemented to collect relevant data along a plurality of critical points along a project implementation path.

7. The AI-assisted project risk detection system of claim 1, wherein the data trackers are implemented to collect relevant data along a plurality of critical points along a product launch plan execution path and at interfaces with external relevant data sources.

8. The AI-assisted project risk detection system of claim 1, wherein the data trackers include Electronic data interchanges (EDIs), application programming interfaces (APIs), and other data feeds and data channels.

9. The AI-assisted project risk detection system of claim 1, wherein the data trackers include localized intelligence to make localized decisions based on localized interpretation and analysis of collected relevant data.

10. The AI-assisted project risk detection system of claim 1, further comprising an administrative interface configured to initialize and implement the data trackers.

11. An AI-assisted project risk detection method comprising:
Installing a plurality of data trackers configured to automatically collect relevant data associated with a project, the relevant data being selected from the group consisting of project scope, project tasks, project management, project risks, project quality, budget, resources, resource allocation, project team members, project team communications, project milestones, project timeline, project status, product launch plan, market trends, economic trends, competitive landscape, legal and regulatory environment, consumer behavior, consumer preferences, customer feedback, and social media;
receiving the relevant data collected by the data trackers, analyzing the relevant data using artificial intelligence to identify emerging vulnerabilities and issues associated with the project, and determining corrective recommendations; and
generating and transmitting notification messages to project team members and stakeholders regarding the identified vulnerabilities, issues, and the corrective recommendations.

12. The AI-assisted project risk detection method of claim 11, further comprising providing a visual interface for use by project team members and stakeholders regarding the identified vulnerabilities, issues, and the corrective recommendations.

13. The AI-assisted project risk detection method of claim 11, further comprising generating and providing detailed reports regarding the identified vulnerabilities, issues, and corrective recommendations.

14. The AI-assisted project risk detection method of claim 11, further comprising automatically generating and transmitting high-level risk notification messages to high-level project members and stakeholders regarding high-level identified vulnerabilities, issues, and corrective recommendations.

15. The AI-assisted project risk detection method of claim 11, further comprising automatically monitoring that the corrective recommended actions are being implemented.

16. The AI-assisted project risk detection method of claim 11, wherein installing the data trackers comprises installing the data trackers to collect relevant data along a plurality of critical points along a project implementation path.

17. The AI-assisted project risk detection method of claim 11, wherein installing the data trackers comprises installing the data trackers to collect relevant data along a plurality of critical points along a product launch plan execution path and at interfaces with external relevant data sources.

18. The AI-assisted project risk detection method of claim 11, wherein installing the data trackers comprises installing data trackers including Electronic data interchanges (EDIs), application programming interfaces (APIs), and other data feeds and data channels.

19. The AI-assisted project risk detection method of claim 11, wherein installing the data trackers include installing data trackers having localized intelligence to make localized decisions based on localized interpretation and analysis of collected relevant data.

20. The AI-assisted project risk detection method of claim 11, further comprising providing a user interface enabling use by at least one administrator to initialize and implement the data trackers.
